(19) United States
(12) Patent Application Publication
(10) Pub. No.: US 2018/0113877 A1
(43) Pub. Date: Apr. 26, 2018

(54) METHOD AND SYSTEM FOR SHARING CONTENT

(71) Applicant: HYPERVERGE INC., Palo Alto, CA (US)

(72) Inventors: Vignesh KRISHNAKUMAR, Chennai (IN); Awanish Raj, Chennai (IN); Sayeed Munawar Hussain, Chennai (IN); Nivedita Muthusubramanian, Rajapalayam (IN); Sanchit Mehta, Rampur (IN); Hariprasad P S, Chennai (IN)

(73) Assignee: HYPERVERGE INC., Palo Alto, CA (US)

(21) Appl. No.: 15/791,326

(22) Filed: Oct. 23, 2017

Related U.S. Application Data
(60) Provisional application No. 62/412,229, filed on Oct. 24, 2016.

(51) Int. Cl. G06F 17/30; H04L 12/44

(52) U.S. Cl. CPC G06F 17/30165; H04L 2012/644; H04L 12/44

(57) ABSTRACT

The present disclosure relates to methods and systems for sharing content, the method comprising receiving at a creator node, a selection of a first set comprising a plurality of joinee nodes, wherein each of said plurality of joinee nodes are associated with a corresponding unique identifier. The process further includes encoding the identifier associated with each of the plurality of joinee nodes in the selected first set and then transmitting the encoded identifiers to at least each of the plurality of joinee nodes in the first set. Next, the process includes receiving an acknowledgement from a subset of the first set, said subset comprising at least two joinee nodes, wherein said acknowledgement indicates a successful connection between the creator node and at least two joinee nodes in the subset. Subsequently, the method creates a network comprising the creator node and said subset and content is shared from the creator node to the subset via the created network.

### BACKGROUND

### Field of the Invention

In general, the present invention relates to content or data processing and more particularly, to systems and methods for sharing content between multiple devices.

### Description of Related Art

In recent times, the number and use of computing devices has increased manifold which has resulted in explosive growth of content sharing. Digital content such as audio, video, images, documents, etc. is shared widely between users. This has necessitated advancements in the way such digital content is shared among people. A very important use case for content sharing among users is many-to-many sharing wherein among a group of people, each person is able to send and receive from everyone else in the group. To cater to this use case, a number of protocols and solutions have been developed to facilitate content sharing. However, these existing solutions have a number of limitations or drawbacks that are discussed in the following paragraphs.

Most of the existing content sharing solutions are web-based, i.e. they require an Internet connection to enable content sharing. Although the speed and cost of Internet connections has considerably improved in the past few years, provision and maintenance of infrastructure required for Internet connectivity still remains a challenge in large parts of the world, specifically in developing countries. Further, the increase in the number of user devices requiring access to fast and unlimited Internet connection has made the provision of internet services even more difficult. Also, the cost of having high speed internet access is a hurdle for many users who cannot afford the same.

Another limitation of existing content sharing solutions is that they are able to provision only one-to-one file transfer and are unable to support content sharing between multiple users connected to each other. Yet another limitation of legacy solutions for offline content transfer, such as Bluetooth or Infrared, is that they require users to manually complete the connection process between their devices to enable content sharing. This manual overhead not only slows down the process but is also redundant in case of many-to-many sharing.

Further, existing solutions for content sharing require devices to be connected to the same Wi-Fi network, or require scanning of a QR code to identify the sender and the receiver devices.

In view of the above and other drawbacks, there exists a need for developing a system and method for many-to-many content sharing between users that enable easy and more efficient content sharing.

This section is intended to provide information relating to the field of the present invention and is only intended to enhance the understanding of the reader with respect to the present disclosure. Any approach/functionality described above should not be assumed to be qualified as prior art merely by its inclusion in this section.

### SUMMARY OF THE INVENTION

This section is intended to introduce certain objects and aspects of the disclosed methods and systems in a simplified form that are further described below in the detailed description. This summary is not intended to identify the key features or the scope of the claimed subject matter.

In view of the afore-mentioned limitations and drawbacks of legacy content sharing solutions, it is apparent that there exists a need for developing a more efficient content sharing solution that not only overcomes the problems of the prior art but also advantageously enables many to many file sharing without the need for manual intervention. It is therefore, an object of the present disclosure to provide efficient systems and methods for offline content sharing between multiple users.

Another object of the invention is to provide efficient systems and methods for content sharing that facilitates simultaneous many-to-many content sharing. Yet another object of the invention is to provide efficient systems and methods for content sharing that facilitate content sharing in a faster and more private manner. Another object of the invention is to provide efficient systems and methods for content sharing that minimizes the overall transfer time and waiting time of multiple devices sharing content.

In view of these and other objects, one aspect of the present disclosure relates to a method for sharing content, the method comprising receiving at a creator node, a selection of a first set comprising a plurality of joinee nodes, wherein each of said plurality of joinee nodes are associated with a corresponding unique identifier. The process further includes encoding the identifier associated with each of the plurality of joinee nodes in the selected first set and then transmitting the encoded identifiers to at least each of the plurality of joinee nodes in the first set. Next, the process includes receiving an acknowledgement from a subset of the first set, said subset comprising at least two joinee nodes, wherein said acknowledgement indicates a successful connection between the creator node and at least two joinee nodes in the subset. Subsequently, the method creates a network comprising the creator node and said subset and content is shared from the creator node to the subset via the created network.

Another aspect of the present disclosure relates to a system for sharing content, the system comprising: a transceiver unit, at a creator node, configured to receive a selection of a first set comprising a plurality of joinee nodes, wherein each of said plurality of joinee nodes are associated with a corresponding unique identifier. The system also comprises an encoder coupled to the transceiver unit, said encoder configured to encode the unique identifier associated with each of the plurality of joinee nodes in the selected first set, wherein the encoded identifiers are transmitted, by the transceiver unit, to each of the plurality of joinee nodes in the first set. Said transceiver unit is further configured to receive an acknowledgement from a subset of the first set, said subset comprising at least two joinee nodes, wherein said acknowledgement indicates a successful connection between the creator node and at least two joinee nodes in the subset. Further, the system also comprises a processing unit coupled to the transceiver unit and the encoder, said processing unit configured to create a network comprising the creator node and said subset, wherein the content is shared, by the transceiver unit, from the creator node to the subset via the created network.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. The connections between the sub-components of a component have not been shown in the drawings for the sake of clarity, therefore, all sub-components shall be assumed to be connected to each other unless explicitly otherwise stated in the disclosure herein.

FIG. 1 illustrates the system for sharing content, in accordance with exemplary embodiment of the present disclosure.

FIG. 2 illustrates the method for sharing content, in accordance with exemplary embodiment of the present disclosure.

FIG. 3 illustrates the process flow of a joinee node in accordance with exemplary embodiments of the present disclosure.

FIGS. 4A and 4B illustrates the process of encoding the identifiers of all the joinee nodes in accordance with exemplary embodiments of the present disclosure.

FIG. 5 illustrates the encoding function, in accordance with exemplary embodiments of the present invention.

FIGS. 6A and 6B illustrates the process of decoding the encoded string of identifiers received at the joinee node.

FIG. 7 illustrates the decoding function, in accordance with exemplary embodiments of the present invention.

FIG. 8 illustrates an exemplary network created in accordance with exemplary embodiments of the present invention.

FIG. 9 shows the process of receiving files at the joinee node in accordance with exemplary embodiment of the present disclosure.

FIG. 10 shows the process of a new client joining the network in accordance with exemplary embodiment of the present disclosure.

FIG. 11 shows the process of a node in an idle state, in accordance with exemplary embodiment of the present disclosure.

### DESCRIPTION OF EXEMPLARY EMBODIMENTS

In the following paragraphs various exemplary embodiments of the present disclosure are described, wherein various specific details are set forth to provide a better understanding of the embodiments. However, it will be appreciated that the disclosed embodiments may be practiced without these specific details. Several features described hereafter can each be used independently of each other with any combination of other features. However, any individual feature may not address any of the problems discussed above or might address only few of the problems discussed above. Although headings are provided, information related to a particular heading, but not found in the section having that heading, may also be found elsewhere in the specification. Further, the information provided under a particular heading may not necessarily be a part of only the section having that heading.

The present disclosure relates to end-to-end systems and methods for facilitating many-to-many content sharing between devices. As used herein, “content” or “file/s” refers to digital content, including by way of non-limiting examples, audio, video, images, documents, animation, interactive content, etc. The systems and methods encompassed by this disclosure facilitate content sharing by discovering devices intending to share content with other devices, connecting these devices over an ad-hoc network without the use of Internet and then simultaneously transferring content between multiple devices using a unique protocol. This process of content transfer directly from one device to other device without the use of a cloud service/server has been herein referred to as offline content sharing. The term ‘sharing’ has been used herein to include both sending and receiving content. Further, as used herein, the terms “send”, “receive”, “transmit” and their cognate terms includes transfer of data, content, information or files form one device to another or one component to another in the form of packets, bits, messages or any other communication element as may be obvious to a person skilled in the art.

The present disclosure encompasses sharing of content between any numbers of computing devices, wherein computing devices include, but are not limited to, a general purpose computer, mobile phone, laptop, desktop, smart phone, personal digital assistant, tablet computer, mainframe computer, or any other computing device as may be obvious to a person skilled in the art.

For the purposes of this disclosure, computing devices that intend to share content with other computing devices are referred to as nodes, wherein each node has a universally unique identification number (ID). In an embodiment, the identifier is a numerical code. The node that initiates content sharing is referred to as the creator node and the nodes with which the creator node intends to share content are known as joinee nodes. However, it may be understood that once a network of the creator and the joinee nodes is created, content can be shared between these nodes irrespective of which node is transmitting and which node is receiving.

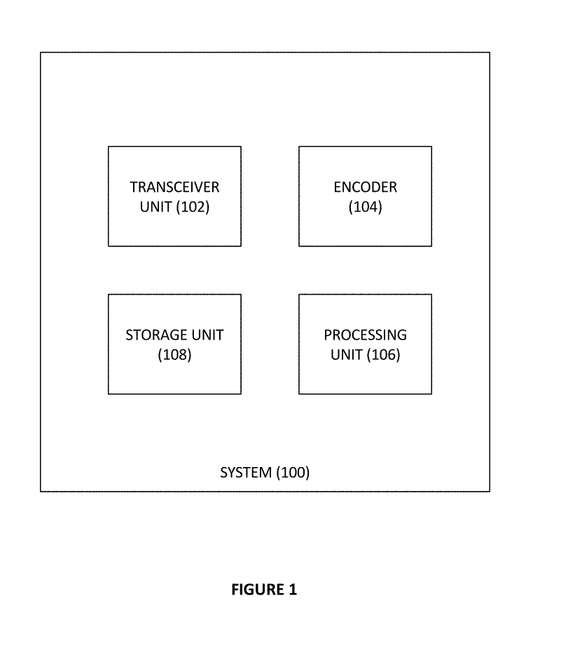

FIG. 1 illustrates the system for sharing content, in accordance with exemplary embodiments of the present disclosure. As shown in FIG. 1, the system 100 comprises a transceiver 102, an encoder 104, a processing unit 106 and a storage unit 108, wherein all of the components are coupled to each other. As used herein, “coupled”, “connected” and “associated” and its cognate terms may refer to a physical connection (such as a wired/wireless connection), a logical connection (such as through logical gates of semiconducting device), other suitable connections, or a combination of such connections, as may be obvious to a person skilled in the art. In an embodiment, the system 100 resides in the creator node.

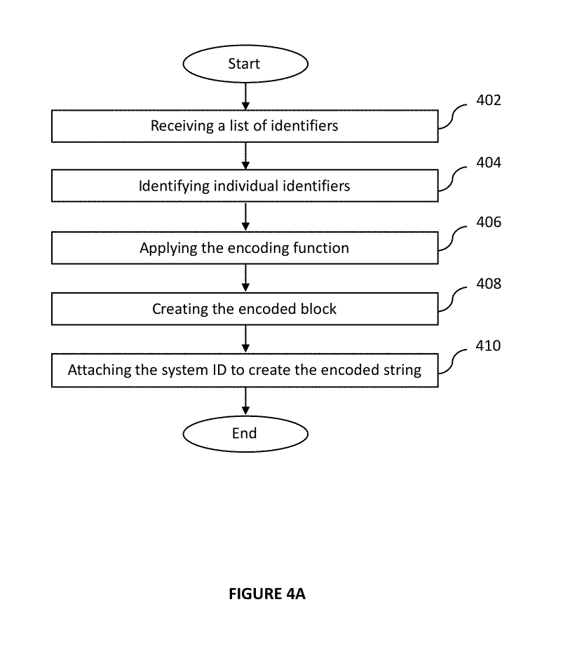

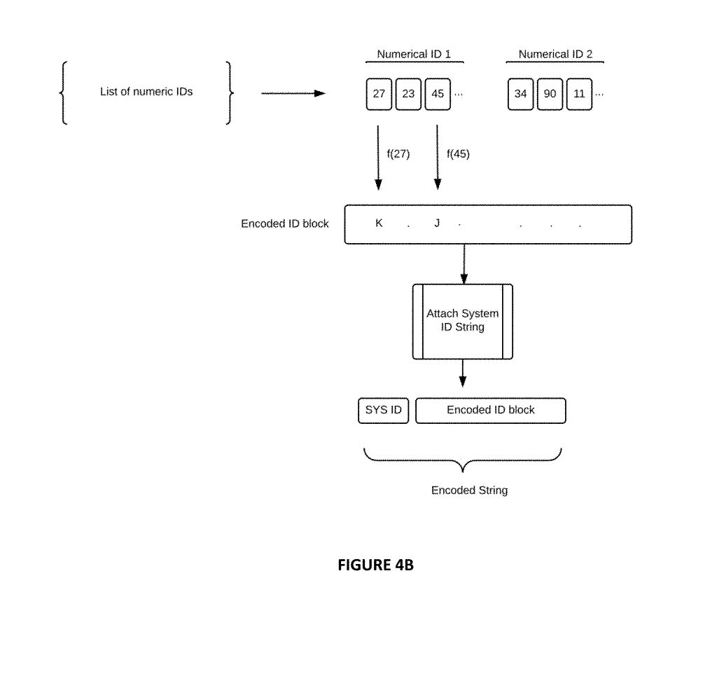

The transceiver 102 is configured to receive a selection of a first set comprising a plurality of joinee nodes, wherein each of said plurality of joinee nodes are associated with a corresponding unique identifier. As used herein, the “first set” refers to a collection of two or more nodes. The selection of first set received at the transceiver unit 102 comprises of a list of nodes along with their corresponding unique identifiers. In an embodiment, the transceiver unit 102 is configured to receive the selection of the first set from a user interface of the creator node. The transceiver unit 102 is further configured to transmit said first set to the encoder 104 that is configured to encode the unique identifier associated with each of the plurality of joinee nodes in the selected first set. The process of encoding has been discussed in detail with reference to FIGS. 4 and 5.

Further, the transceiver unit 102 is also configured to create an ad-hoc network comprising the joinee nodes in the first set, wherein this network is formed by transmitting a network configuration message including the encoded identifiers to at least the joinee nodes in the first set. In an embodiment, the ad-hoc network is broadcast and is discoverable by nodes/devices in a pre-defined network range. The ad-hoc network is built dynamically as joinee nodes keep connecting to the network. The transfer of information or data between the nodes in the ad-hoc network are not coordinated through any one node, instead packets are transmitted from one node to another in a random fashion or in accordance with known routing protocols for ad hoc networks as may be obvious to a person skilled in the art.

The transceiver unit 102 is also configured to receive an acknowledgement from a subset of the first set, said subset comprising at least two joinee nodes. As used herein, the “acknowledgement” refers to a message or data packet that indicates a successful connection between two or more nodes. Also, a “negative acknowledgement” as used herein, refers to a message or data packet that indicates that establishment of connection between two or more nodes has failed. A negative acknowledgement may be received from a node when the data packet received by that node does not contain the encoded identifier of that node, or when the node fails to establish the connection due to any other reason. In an embodiment, when the connection fails, the node may not send the negative acknowledgement to the creator node.

Further, a “subset” refers to a set of nodes that is a part of the first set such that the number of nodes in the subset is not greater than the number of nodes in the first set, and every node in the subset is also present in the first set. In an embodiment, the subset may contain the same number of nodes as that of the first set, while in another embodiment, the subset may be a null set. For instance, if the first set comprises of 5 nodes, namely A, B, C, D and E, and the transceiver unit 102 receives an acknowledgement from nodes C and D, while it receives a negative acknowledgement or no acknowledgement from nodes A, B and E. In this scenario, the subset comprises nodes C and D.

The processing unit 106 is configured to create a network comprising the creator node and the plurality of nodes in the subset. Through this network, content is shared by the transceiver unit 102 with plurality of joinee nodes in the subset. The nodes in the created network are arranged in a star topology, wherein the creator node becomes the central node of the star and the plurality of joinee nodes in the subset become the leaf nodes. In an embodiment, the network is not a new network that is formed between the creator node and the joinee node, but instead the network is a re-arrangement of the nodes already present in the ad-hoc network in a star topology as described above.

The storage unit 108 is configured to store the identifier of the creator node, the selection of the first set of joinee nodes, the subset of the first set comprising plurality of joinee nodes, the identifiers of each of the nodes in the first set and the subset, etc. The storage unit 108 may further be configured to store a list of networks formed by the processing unit 106, the ad-hoc networks formed by the processing unit 106, the network configuration information associated with each of these networks and ad-hoc networks, etc. The invention also encompasses a storage unit 108 configured to store an overall file table wherein a list of all files to be received from one or more other nodes in the network are stored.

Each of the joinee nodes in the network also comprise of a transceiver unit and a processing unit, wherein the transceiver unit is configured to receive encoded list of identifiers from the transceiver unit 102 of the creator node, and the processing unit is configured to constantly or periodically check for networks, decode the encoded identifiers received and connect to the network.

The network and the ad-hoc network may be established by one or more mediums such as Bluetooth, Wi-Fi, etc. Similarly, the background scanning performed by the joinee nodes may be Bluetooth Low Energy scan, or Wi-Fi network scan, etc.

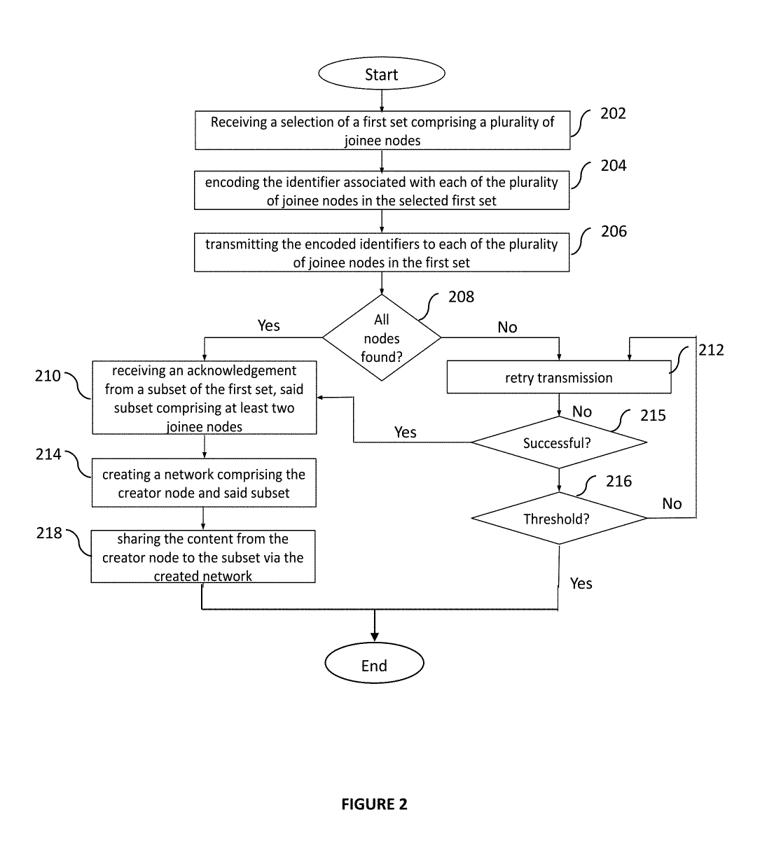

FIG. 2 illustrates the method for sharing content, in accordance with exemplary embodiments of the present disclosure. The method begins at step 202, wherein a selection of a first set comprising a plurality of joinee nodes is received at the creator node, each of said plurality of joinee nodes being associated with a unique identifier. The selection of the first set is received at the transceiver unit 102 of the creator node. In an embodiment, this selection is made by a user of the creator node, while in another embodiment, the selection is made automatically by one or more hardware or software components. The selection may be made by a user by means of the user interface of the creator node, wherein the user may manually select other nodes (from a list of displayed joinee nodes) with which he wishes to share content.

The invention encompasses firstly broadcasting an ad-hoc network by the creator unit, such that the network is discoverable by nearby joinee nodes. Once the joinee nodes discover the network, they transmit a request to join the network which when received at the creator node is accepted or rejected by the user or the software or hardware components. A list of all the joinee nodes whose request to join the ad-hoc network has been accepted by the creator node then form the first set of nodes that are provided to the transceiver unit 102 of the creator node.

At step 204, the identifiers associated with each of the plurality of joinee nodes in the selected first set are encoded, wherein the process of encoding has been discussed in detail with reference to FIGS. 4 and 5. This step also includes determining whether the received first set contains any errors such as missing identifier, or missing device name, etc.

At step 206, the encoded identifiers are transmitted to each of the plurality of joinee nodes in the first set, wherein the encoded identifiers may be a part of a network configuration message. In an embodiment, prior to the transmission of the encoded identifiers, an ad-hoc network comprising the creator node and the plurality of joinee nodes in the selected first set is created, and the encoded identifiers are transmitted via this ad-hoc network. The creation of ad-hoc network occurs in accordance with any of the known methods as obvious to a person skilled in the art. Each of the plurality of nodes in the ad-hoc network may participate in routing by forwarding the encoded identifiers to other nodes.

At step 208, the method determines if all the joinee nodes in the first set have been identified and the encoded identifiers have been transmitted to all such nodes. In an embodiment, the method determines if all the joinee nodes in the first set have been added to the ad hoc network. In case all nodes have been identified the method proceeds to step 210 else to step 212.

At step 210, an acknowledgement is received from a subset of the first set, said subset comprising at least two joinee nodes, wherein the acknowledgement indicates a successful connection between the creator node and the at least two joinee nodes in the subset. The invention encompasses a process wherein the creator node waits for an acknowledgement from the joinee nodes for a predetermined period of time, said period may be pre-configured or user-configurable. For instance, once the encoded identifiers are sent to all the nodes in the ad-hoc network, the creator node may wait for acknowledgement and/or negative acknowledgement from one or more joinee nodes for a period of 1.5 minutes, and if no message is received within this time period, the process may abort or transmission of encoded identifiers to the joinee nodes in step 206 may be re-tried. This re-transmission is attempted only for a pre-determined number of times after which the process comes to an end.

Subsequently, at step 214, based on this acknowledgement, a network comprising the creator node and the plurality of nodes in the subset is created, wherein nodes in said network are arranged in a star topology. Subsequently, in step 218, content is shared between the creator node and said joinee nodes in the subset via this created network.

If all the joinee nodes in the first set have not been identified at step 208, then the process proceeds to step 212 wherein transmission of encoded identifier is re-tried. In an embodiment, re-transmission is attempted only for the nodes that have not been identified at step 208, while in another embodiment, re-transmission is attempted for all the nodes in the ad-hoc network. Subsequently, the process proceeds to step 215, wherein it is determined whether transmission attempted at step 212 has been successful. In the affirmative, the process proceeds to step 210 else to step 216, wherein the process determines if a threshold value of re-transmission has been reached. This threshold value indicates the maximum number of times the process attempts re-transmission before the process is aborted. In case the threshold value has been reached, the process ends, however, if the threshold value has not been reached, the process proceeds back to step 212 wherein transmission of encoded identifiers is again attempted.

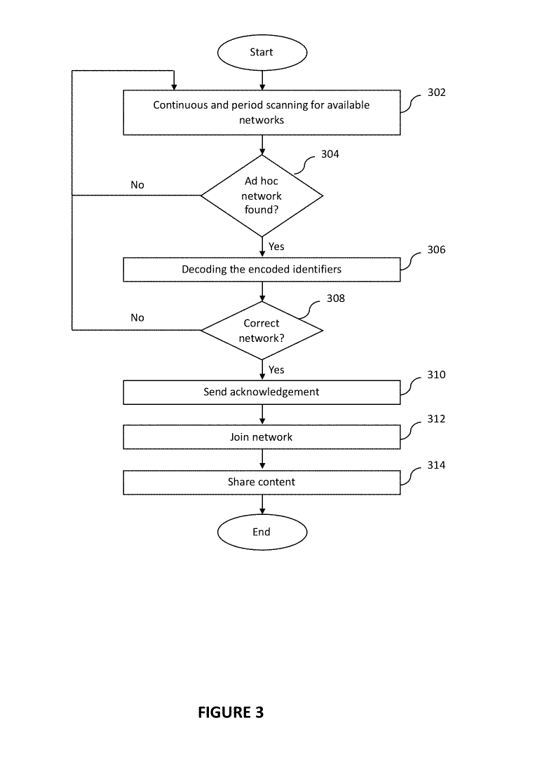

FIG. 3 illustrates the process flow of a joinee node in accordance with exemplary embodiments of the present disclosure.

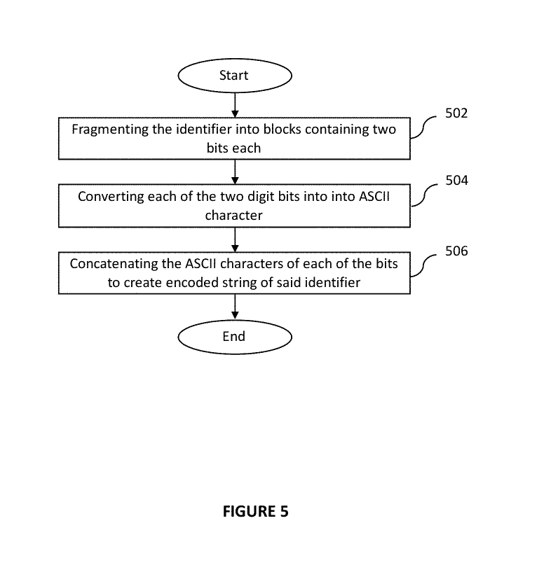

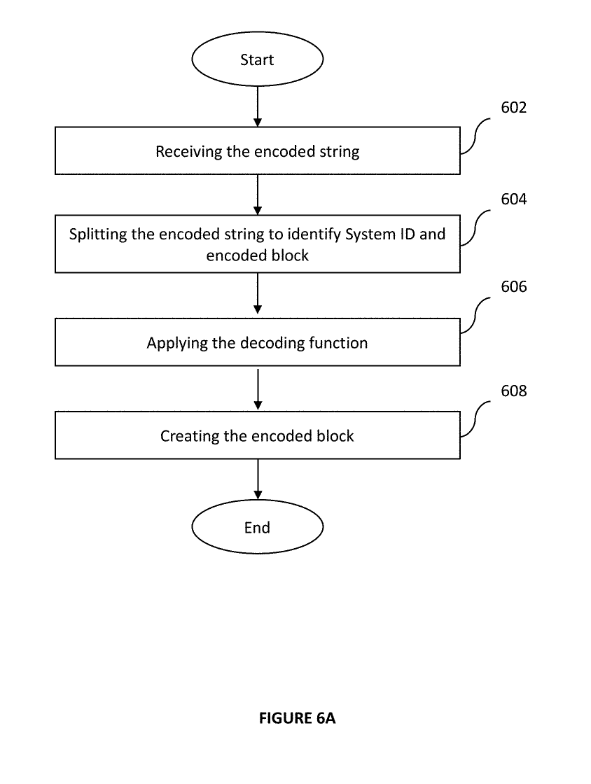

The process begins at step 302 wherein each joinee node continuously and periodically scans for available networks, wherein said period of scanning may be pre-configured or user configurable. At step 304, the process checks for existence of any ad-hoc networks created by the creator node. In case the ad-hoc network is found, the process proceeds to step 306 else back to step 302. At step 306, the encoded identifiers are decoded, wherein the process of decoding have been discussed in detail with reference to FIGS. 6 and 7.

At step 308, the process filters the detected ad-hoc networks by identifying if the identifier of the joinee node is found in the decoded list of identifiers obtained at step 306. If the decoded identifiers contain the identifier of the joinee node, then the process proceeds to step 310 else it proceeds back to step 302. At step 310, the joinee node sends an acknowledgement to the creator node, wherein the acknowledgment indicates establishment of a successful connection between the creator node and the joinee node. Subsequently, at step 312, the joinee node joins the network created by the creator node and content sharing occurs at step 314 subsequent to which the process ends. In an embodiment, the joinee node establishes a socket connection with the creator node.

FIGS. 4A and 4B illustrates the process of encoding the identifiers of the joinee nodes in accordance with exemplary embodiments of the present disclosure. The method begins at step 402 wherein a list of identifiers of the plurality of joinee nodes in the first set are received at the creator node. At step 404, the identifiers of these nodes are separated and for each of these identifiers the encoding function is performed as discussed with reference to FIG. 5. Subsequent to encoding of each of the identifiers in the list, the process proceeds to step 408, wherein an encoded block is created by combining the encoded identifiers into one data block. Next, at step 410, a system ID of the network is appended to the encoded block to create an encoded string. Thus, the encoding of each identifier results in an ‘encoded string of that identifier/node’. The encoded string of each of the identifiers concatenated together are referred to as an ‘encoded block’, which when appended with the system ID of the network is referred to as the ‘encoded string’.

FIG. 5 illustrates the process of encoding an identifier of a joinee or creator node, in accordance with exemplary embodiments of the present invention. At step 502, the identifier of the node is fragmented into blocks containing two bits each. For instance, consider that the identifier of a block is 5427447882. This is fragmented into pairs of bits 54-27-44-78-22. Subsequently, at step 504 each of the pairs formed in the previous step are converted into a single ASCII character in accordance with the following formula:

n→ASCII char(n+c), where c is a constant such that 0<=c<=28.

For instance, in the above example, for c=11, the following conversions occur in step 504:

| Fragmented pair | Corresponding ASCII |
|---|---|
| of identifier bits | character formed |
| 54 | A |
| 27 | & |
| 44 | 7 |
| 78 | Y |
| 22 | ! |

The value of the constant may be selected in accordance with a function, or may be randomly selected by the creator node. Next, at step 506, the ASCII characters formed in the previous step are concatenated into a single encoded string. In the above example the encoded string formed for the identifier 5427447882 is ‘A&7Y!’

FIGS. 6A and 6B illustrates the process of decoding the encoded string of identifiers received at the joinee node. The process begins at step 600 wherein the encoded string is received at the joinee node. At step 602, the process includes fragmenting the encoded string to identify the system ID of the network and the encoded block. The encoded ID block is further fragmented to identify the encoded identifiers contained therein. Subsequently, at step 606, each of the identifiers identified in the previous step are decoded in accordance with the process explained with reference to FIG. 7. Next, at step 608, all the decoded identifiers are analysed to determine if the identifier of the joinee node matches with any of the decoded identifiers. This step includes comparing the decoded identifiers with the identifier of the joinee node in accordance with methods known to a person skilled in the art.

FIG. 7 illustrates the process of decoding an identifier of a joinee or creator node, in accordance with exemplary embodiments of the present invention. At step 702, the encoded string of the identifier is fragmented to identify each bit of the encoded string. For instance, for the encoded string ‘BDF4?’ the bits ‘B’, ‘D’, ‘F’, ‘4’ and ‘?’ are identified. Next, at step 704, the each identified bit is converted into a two-digit number in accordance with the following formula.

char→(ASCII value of the char−c), where c is a constant such that 0<=c<=28.

The value of the constant may be selected in accordance with a function or may be selected based on the value received in the network configuration message. For instance, in the above example, for c=11, the following conversions occur in step 704:

| Identified | ASCII value | Converted two-digit |
|---|---|---|
| bits (char) | of the char | number |
| B | 66 | 55 |
| D | 68 | 57 |
| F | 70 | 59 |
| 4 | 52 | 41 |
| ? | 63 | 52 |

Subsequently, at step 706, two-digit numbers formed in the previous step are concatenated to form the decoded identifier of the node. For instance, in the above example, the decoded identifier of the node formed in this step is ‘5557594152’.

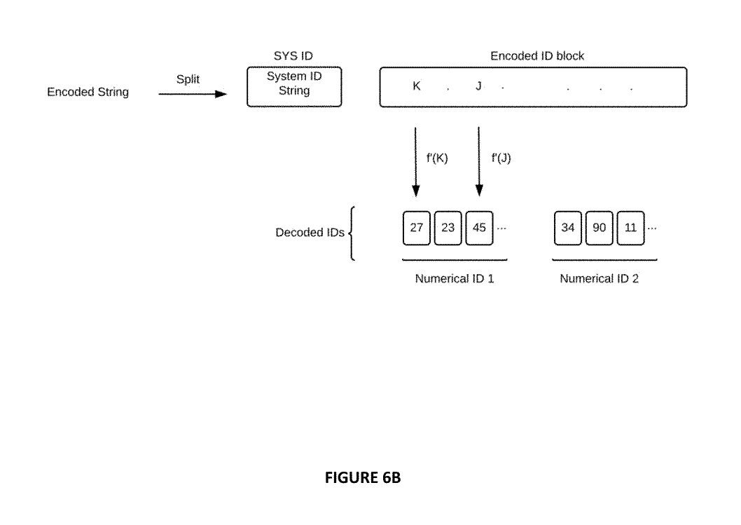

FIG. 8 illustrates an exemplary network created in accordance with exemplary embodiments of the present invention. The creator node/server node 802 acts as the central node of the star topology and the joinee nodes 804, 806, 808 are all connected to this creator node 802. The creator node 802 thus acts as a common connection point for all joinee nodes 804, 806, 808 and facilitates transmission of content from one node to another in the star network. All the content/files shared between any of the nodes of the network occur through creator node. Although only three joinee nodes are shown in FIG. 8, it will be appreciated by those skilled in the art that any number of joinee nodes may be connected to the creator node and the same is encompassed by this disclosure.

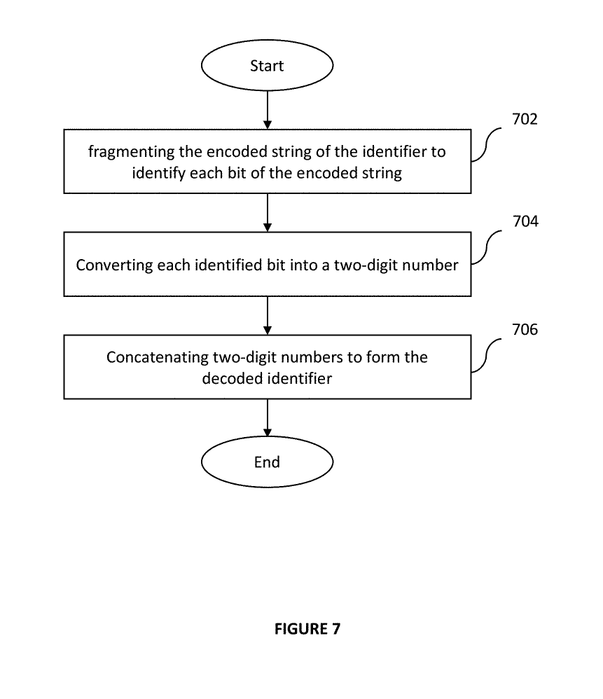

Once the network is formed and connections between creator nodes and joinee nodes are established, the sharing or transfer of content from one node to another takes place in accordance with the process as described with reference to FIGS. 9, 10 and 11.

FIG. 9 shows the process of receiving files at the joinee node. Once the network is formed, at 902, the creator node sends a “FT-RES” message to the one or more joinee nodes in the network, said message comprising a list of files/content that the creator node wishes to transfer. When this message is received at the joinee node's, the joinee node sends a “DT_REQ” message comprising a request for a file in the received list of the files/content. At 904, the “DT_REQ” message is received at the creator node in response to which the creator node sends a “DT_RES” message, wherein this message indicates that the file is ready for transfer. When the “DT_RES” message is received at the joinee node, it sends a “DT_ACK” message comprising an acknowledgement message for priority file download of this particular file. At 906, the “DT_ACK” message is received at the creator node in response to which it sends the data to the joinee node/s. When this data is received at the joinee node/s, it sends another “DT_REQ” and/or a “THANKS” message to the creator node, wherein the “DT_REQ” message comprises a request for transfer of another file in the list and “THANKS” message comprises an acknowledgement that the file/content has been successfully received at the joinee node/s.

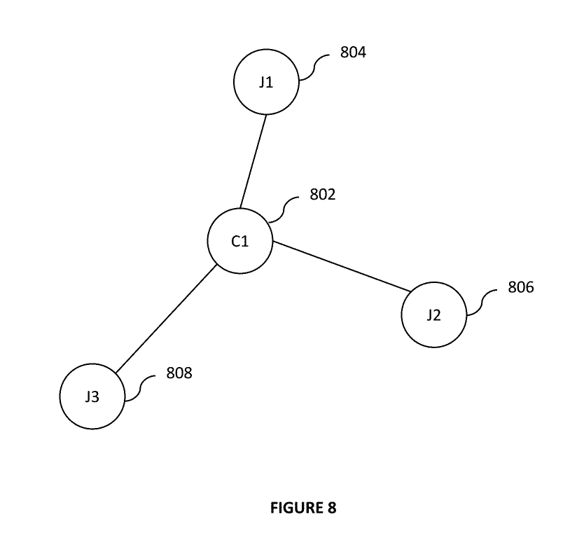

FIG. 10 shows the process when a new client joins the network. As shown in 1002, when a new joinee node joins the network, the central node sends a “HELLO” message, i.e. a test message to the joinee node in response to which the joinee node sends an “IDENTIFY” message to the creator node, wherein the “IDENTIFY” message comprises at least the unique identification number of the joinee node. Subsequently, at 1004 the “IDENTIFY” message is received at the creator node in response to which the creator node sends an “ACCEPTED” message, wherein this message indicates acceptance of the joinee node to join the network. The “ACCEPTED” message is created based on authentication of the joinee node, wherein authentication is further based on its identification. When the “ACCEPTED” message is received at the joinee node, it sends to the central node, a “FT-RES” message comprising a list of files/content that the joinee node wishes to transfer. At 1006, the central node receives the message “FT_RES” in response to which the creator node sends a message “DT_REQ” to the joinee node, wherein this message is a request for a file in the received list of the files/content. When this “DT_REQ” message is received at the joinee node, it sends the requested file/content to the creator node. At 1008, this file/content is received at the creator node in response to which it sends another “DT_REQ” and/or a “PENDING” message to the joinee node. The “PENDING” message comprises a list of files pending to be received from the joinee node. Once all the files are received by the creator node, the process ends.

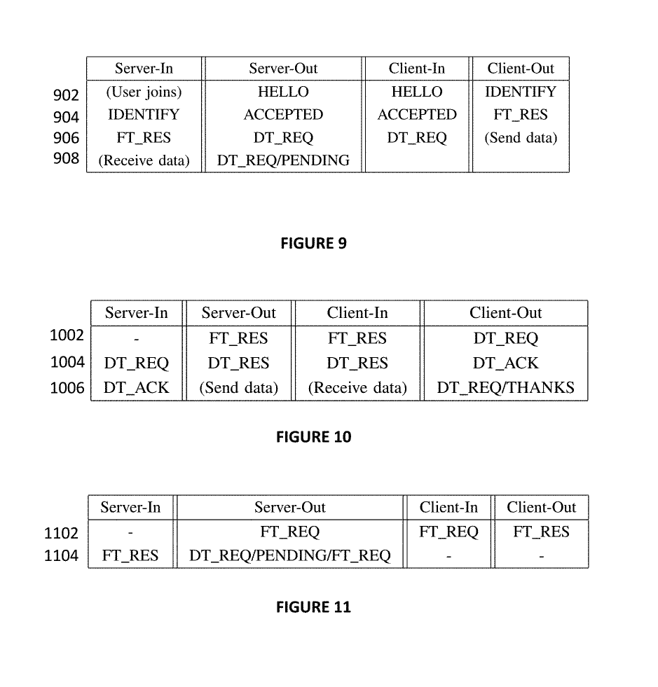

The invention encompasses that the creator node maintains an overall file table wherein a list of all files to be shared between one or more other nodes in the network, are stored. Upon receiving a list of files/content that the creator/joinee node wishes to transfer, the creator node updates the overall file table and transmits an “UPDATE” message to all the nodes which indicates that the creator node now has new files to send to the joinee nodes. Upon receiving this “UPDATE” message, the joinee nodes start requesting for each of these files from the creator node. Finally, as shown in FIG. 11, when the creator node has no more content/files to send, it is in an idle state, wherein the creator node keeps sending periodically, at 1102, the “FT_REQ” message requesting to receive more files from the joinee nodes. If any of the joinee nodes have any content/files to be shared, the joinee nodes responds to this “FT_REQ” message by sending a “FT_RES” message, at 1104, comprising a list of files to be shared and the process of content/file sharing resumes. Thus, the aforementioned protocol ensures that content transfers are non-blocking, simultaneous and multi-way. It optimizes both on the waiting time of each node as well as the overall time taken for transferring all the files to all the nodes.

The invention encompasses sharing/transfer of multiple files between the nodes of an ad-hoc network, i.e. the ad-hoc network is generated once, while content sharing over the network is a dynamic routine that can reoccur on the already generated network. The invention also encompasses sharing/transfer of multiple files to and from the central node like the joinee node/s. Further, the invention also encompasses sharing/transfer of files from a joinee node/central node to all other nodes of the ad-hoc network.

The present invention is advantageous over the prior art systems since it is made to function without manual intervention over an ad-hoc network (created from a mobile hotspot, for example), without the use of internet, using a novel technique to encode information in the advertised network and decode information from discovered networks. The new optimized protocol for simultaneous many-to-many sharing of files among devices minimizes the overall transfer time and the waiting time of each node in the network.

The protocol as mentioned above runs efficiently over any connectivity method that exposes a framework for advertising and discovering networks. The protocol also effectively optimizes on the waiting time for each node and the total time for sharing by scheduling appropriate simultaneous transfers. The whole process has also been automated through a novel technique of encoding information in advertising and decoding information at the time of discovery.

While this invention has been particularly shown and described with references to example embodiments thereof, it will be understood by those skilled in the art that various changes in form and details may be made therein without departing from the scope of the invention.

What is claimed is:

1. A method for sharing content, the method comprising:
receiving a selection of a first set, at a creator node, said first set comprising a plurality of joinee nodes, wherein each of said plurality of joinee nodes are associated with a corresponding unique identifier;
encoding the identifier associated with each of the plurality of joinee nodes in the selected first set;
transmitting the encoded identifiers to each of the plurality of joinee nodes in the first set;
receiving an acknowledgement from a subset of the first set, said subset comprising at least two joinee nodes, wherein
said acknowledgement indicates a successful connection between the creator node and at least two joinee nodes in the subset;
creating a network, based on said acknowledgement, said network comprising the creator node and said subset; and
sharing the content from the creator node to the subset via the created network.

2. The method of claim 1, further comprising creating an ad-hoc network comprising the creator node and the selected first set, wherein the ad-hoc network is configured to transmit the encoded identifiers to each of the plurality of joinee nodes in the first set.

3. The method of claim 1 may further comprise authenticating the at least two joinee nodes in the subset, at the creator node.

4. The method of claim 1, wherein receiving the acknowledgement from a subset of the first set is based on decoding of the encoded identifiers.

5. The method of claim 1 may further comprise transmitting a pending update message from the creator node to the at least two joinee nodes in the subset based on a status of the content shared with said at least two joinee nodes.

6. A system for sharing content, the system comprising:
a transceiver unit, at a creator node, configured to receive a selection of a first set comprising a plurality of joinee nodes, wherein each of said plurality of joinee nodes are associated with a corresponding unique identifier;
an encoder coupled to the transceiver unit, said encoder configured to encode the unique identifier associated with each of the plurality of joinee nodes in the selected first set, wherein
the encoded identifiers are transmitted, by the transceiver unit, to each of the plurality of joinee nodes in the first set;
said transceiver unit further configured to receive an acknowledgement from a subset of the first set, said subset comprising at least two joinee nodes, wherein
said acknowledgement indicates a successful connection between the creator node and at least two joinee nodes in the subset;
a processing unit coupled to the transceiver unit and the encoder, said processing unit configured to create a network, based on said acknowledgement, said network comprising the creator node and said subset,
wherein the content is shared, by the transceiver unit, from the creator node to the subset via the created network.

7. The system of claim 6 wherein the network is in a star topology, wherein the creator node is a central node of the star and each of the at least two joinee nodes in the subset is a leaf node.

8. The system of claim 6, further comprising a storage unit configured to store at least a list of said content.
